(19) United States
(12) Patent Application Publication
(10) Pub. No.: US 2023/0109632 A1
(43) Pub. Date: Apr. 6, 2023

(54) METHOD OF ESTIMATING SOLID SOLUTION AMOUNT OF ADDITIVE ELEMENT IN ALUMINUM ALLOY, METHOD OF PRODUCING SPECIMEN, AND STRENGTH EVALUATION METHOD USING THE SAME

(71) Applicant: HITACHI ZOSEN CORPORATION, Osaka (JP)

(72) Inventors: Hikaru Takeuchi, Osaka (JP); Katsunori Kusunoki, Osaka (JP); Akira Higuchi, Osaka (JP)

(21) Appl. No.: 17/960,496

(22) Filed: Oct. 5, 2022

(30) Foreign Application Priority Data
Oct. 6, 2021 (JP) 2021-164371

(51) Int. Cl. C22C 21/00; C22F 1/04; C22C 21/06

(52) U.S. Cl. CPC C22C 21/00; C22F 1/04; C22C 21/06

(57) ABSTRACT

Provided is a method of estimating a solid solution amount of Mg for estimating a change with time of the solid solution amount of Mg which is an example of additive elements in an aluminum alloy. The method of estimating the solid solution amount of Mg includes a step of identifying a precipitate of the aluminum alloy with an equilibrium diagram prepared by simulation based on the CALPHAD method. The method of estimating the solid solution amount of Mg further includes a step of estimating the change with time of the solid solution amount of Mg from the identified precipitate with simulation based on the Langer-Schwartz theory and a numerical solution with the Kampmann-Wagner method.

### CROSS-REFERENCE TO RELATED APPLICATIONS

This Application claims priority to Japanese Patent Application No. 2021-164371, filed Oct. 6, 2021, the contents of which is incorporated herein by reference in its entirety.

### BACKGROUND

### Technical Field

The present disclosure relates to a method of estimating a solid solution amount of an additive element in an aluminum alloy, a method of producing a specimen, and a strength evaluation method using the same.

### Description of Related Art

In general, heating a metal material changes the property (metallographic structure) to deteriorate the strength under some heating conditions. When a metallic member is used under a heating condition at high temperature for a long time, the strength is evaluated with consideration of a metallographic state after the use.

Examples of a product used under a heating condition at high temperature for a long time include “metal cask”, a container for transporting and storing spent fuel generated in nuclear power facilities. A basket, a member in the metal cask, which holds the spent fuel, is heated at approximately 100° C. to 200° C. with decay heat of the spent fuel. A heated term of the basket (designed storage term) is maximum 60 years including transportation before and after the storage. Required for a material used for the basket is safety function not impaired in the designed storage term, and the strength is evaluated by using a specimen having a simulated metallographic structure after the use.

For example, disclosed as Non-Patent Literature 1 is “Codes for Construction of Spent Nuclear Fuel Storage Facilities—Rules on Transport/Storage Packagings for Spent Nuclear Fuel—(2007)” published by The Japan Society of Mechanical Engineers in February 2008. Non-Patent Literature 1 describes production of a specimen subjected to an aging treatment with a higher temperature and a shorter time than a thermal history in the designed storage term for a basket material (for example, an aluminum alloy) to perform a strength evaluation.

As a procedure of simulating the metallographic state of the actual product used under the heating condition at high temperature for a long time, a method of producing a specimen by subjecting to heat treatment same as the heating condition of the actual product may be suggested. However, on a product such as the metal cask having a designed storage term of maximum 60 years, it is difficult to experimentally perceive the metallographic structure after the use.

As described in Non-Patent Literature 1, it is desirable to produce a specimen subjected to an aging treatment with a higher temperature and a shorter time than a thermal history in the designed storage term for a basket material to perform a strength evaluation.

Some elements added into the material increase the solid solution limit to the base material with rise in temperature. For example, Mg in an aluminum alloy subjected to an aging treatment at higher temperature than a temperature in use of the actual product increases the solid solution amount in the base phase to increase the material strength. The method of producing a specimen described in Non-Patent Literature 1 ignores such a change in the solid solution limit of the additive element, and the specimen subjected to only the aging treatment at higher temperature than the temperature in the designed storage term is considered to have higher strength than the material after the designed storage term.

An object of the present disclosure is to provide a method of estimating a solid solution amount of an additive element in an aluminum alloy that can appropriately evaluate the change in the material property due to heating of the metal material, a method of producing a specimen, and a strength evaluation method using the same.

### SUMMARY

In order to solve the problem, a method of estimating a solid solution amount of an additive element according to the present disclosure is a method of estimating a solid solution amount of an additive element for estimating a change with time of the solid solution amount of the element added into an aluminum alloy, the method including the steps of:

identifying a precipitate of the aluminum alloy with an equilibrium diagram prepared based on the CALPHAD method; and

estimating the change with time of the solid solution amount of the additive element with the Langer-Schwartz theory and a numerical solution with the Kampmann-Wagner method based on the identified precipitate.

A method of producing a specimen according to the present disclosure is a method of producing a specimen simulating a change with time of a metallographic structure in a designed storage term of an aluminum alloy for a basket used for a metal cask, the method including steps of:

calculating a condition of an overaging heat treatment corresponding to a thermal history in the designed storage term of the aluminum alloy for a basket with a Larson-Miller equation using a constant obtained in a creep rupture test; and

performing the overaging heat treatment on an aluminum alloy to be a base material of the specimen based on the calculated condition of the overaging heat treatment.

The method of estimating a solid solution amount of an additive element can improve the estimation accuracy.

### BRIEF DESCRIPTION OF THE DRAWINGS

FIG. 1 is a graph indicating influence of additive elements on a recrystallization temperature of aluminum;

FIG. 2A is a binary phase diagram of Al—Mn (aluminum side);

FIG. 2B is a binary phase diagram of Al—Mn (whole system);

FIG. 3 is a binary phase diagram of Al—Mg;

FIG. 4 is a schematic diagram of an overaging heat treatment;

FIG. 5 is a schematic diagram relating to a method of determining an addition amount of Mg into a specimen for a mechanical test;

FIG. 6 is a temperature-time graph indicating a method of producing a specimen for a mechanical test;

FIG. 7 is a flowchart indicating a heat treatment condition of a specimen for a mechanical test;

FIG. 8 is an equilibrium diagram of a specimen (A5083);

FIG. 9 is a graph indicating a change in volume fractions of a precipitate with a heat treatment of a specimen;

FIG. 10 is a graph indicating a change in a solid solution amount of Mg with a heat treatment of a specimen;

FIG. 11 is an equilibrium diagram of a specimen (HZ-A3004-H112);

FIG. 12 is a graph indicating a change in volume fractions of a precipitate with a heat treatment of HZ-A3004-H112;

FIG. 13 is a graph indicating a change in solid solution amounts of elements with a heat treatment of HZ-A3004-H112;

FIG. 14 is a graph indicating a change in an electroconductivity with a heat treatment of HZ-A3004-H112;

FIG. 15A is a temperature-time graph indicating a heating condition of a designed storage term applied to a simulation;

FIG. 15B is a temperature-time graph indicating a heating condition of a heat treatment applied to a simulation;

FIG. 16 is an equilibrium diagram of HZ-A3004-H112;

FIG. 17 is a graph indicating a designed storage term and change in a solid solution amount of Mg with a heat treatment of HZ-A3004-H112;

FIG. 18 is a graph indicating a change in a solid solution amount of Mg with a heat treatment of a specimen for a mechanical test;

FIG. 19 is a flowchart indicating a production condition of a specimen for a mechanical test simulating a material strength of HZ-A3004-H112 in a designed storage term;

FIG. 20 is a graph indicating a change in a solid solution amount of Mg with respect to components in a mill test certificate of a specimen;

FIG. 21 is a graph indicating a change in volume fractions of a precipitate with respect to components in a mill test certificate of HZ-A3004-H112 in a designed storage term (200° C.×60 years);

FIG. 22 is a graph indicating a change in volume fractions of a precipitate with respect to components in a mill test certificate of a specimen for the mechanical test with a heat treatment;

FIG. 23 is a graph indicating a relationship between a test temperature and 0.2%-proof stress of HZ-A3004-H112 (initial material) and a specimen for the mechanical test (heat-treated material);

FIG. 24 is a graph indicating a relationship between a test temperature and tensile strength of HZ-A3004-H112 (initial material) and a specimen for the mechanical test (heat-treated material);

FIG. 25 is a flowchart of a method of estimating a solid solution amount of Mg according to an embodiment of the present disclosure;

FIG. 26 is a flowchart when the method of estimating a solid solution amount of Mg include a step of regulating and inputting an interface energy;

FIG. 27 is a flowchart of a method of producing a specimen according to an embodiment of the present disclosure; and

FIG. 28 is a flowchart when the method of producing a specimen includes a step of adding a reduced amount of Mg.

### DETAILED DESCRIPTION

Described below are a method of estimating a solid solution amount of an additive element, a method of producing a specimen, and a strength evaluation method using the same according to an embodiment.

### [Method of Estimating Solid Solution Amount of Additive Element]

First, a method of estimating a solid solution amount of Mg will be described as an example of the method of estimating a solid solution amount of an additive element. The additive element at a solid solution amount estimated with the method of estimating a solid solution amount of an additive element is certainly not limited to Mg. For example, the estimated additive element is at least one of Mg, Mn, Fe, Si, Cu, and Zn.

The method of estimating a solid solution amount of Mg is a method of estimating a change with time of a solid solution amount of Mg in an aluminum alloy. The aluminum alloy in the method of estimating a solid solution amount of Mg may be an aluminum alloy for a basket used for the metal cask, and may be an aluminum alloy used for a specimen. When the aluminum alloy in the method of estimating a solid solution amount of Mg is the aluminum alloy for a basket used for the metal cask, a term of estimating the change with time of the solid solution amount of Mg is a designed storage term of the aluminum alloy for a basket (for example, 60 years).

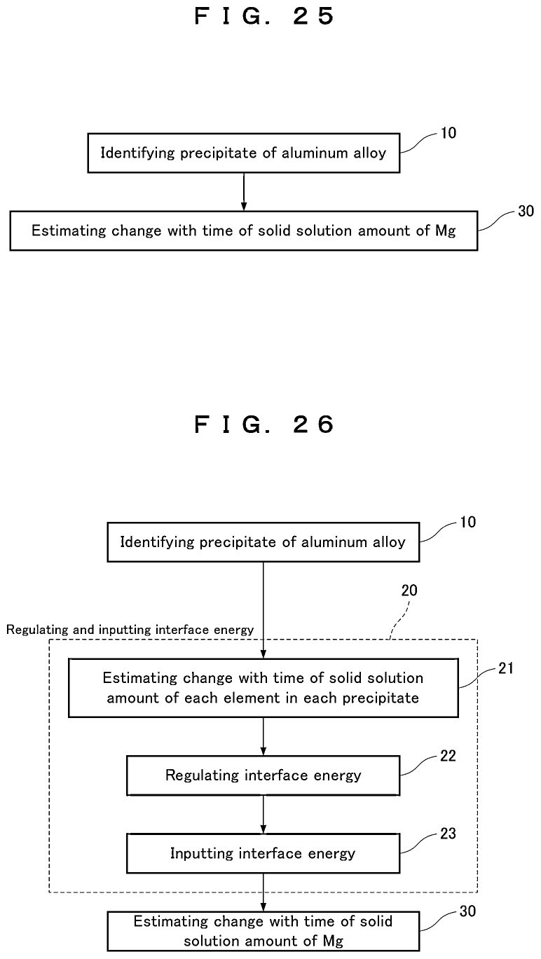

As indicated in FIG. 25, the method of estimating a solid solution amount of Mg includes: a step 10 of identifying a precipitate of the aluminum alloy with an equilibrium diagram prepared with a simulation based on the CALPHAD method; and a step 30 of estimating the change with time of the solid solution amount of Mg with a simulation with the Langer-Schwartz theory and a numerical solution with the Kampmann-Wagner method based on the identified precipitate.

That is, the step 10 identifies the precipitate of the aluminum alloy with the equilibrium diagram prepared based on the CALPHAD method. Then, the step 30 estimates the change with time of the solid solution amount of Mg with the Langer-Schwartz theory and the numerical solution with the Kampmann-Wagner method, based on the identified precipitate.

As described, the method of estimating a solid solution amount of Mg combines the CALPHAD method, the Langer-Schwartz theory, and the numerical solution with the Kampmann-Wagner method to estimate the change with time of the solid solution amount of Mg in the aluminum alloy, and thereby the method can improve the estimation accuracy compared with the classical nucleation theory.

As indicated in FIG. 26, the method of estimating a solid solution amount of Mg may further include a step 20 of regulating and inputting an interface energy, between the step 10 and the step 30.

The step 20 includes a step 21, a step 22, and a step 23. The step 21 estimates a change with time of a solid solution amount of each element in each of the precipitate with the Langer-Schwartz theory and the numerical solution with the Kampmann-Wagner method, based on the identified precipitate. The step 22 regulates the interface energy of each of the precipitate for an input to the simulation based on the Langer-Schwartz theory and the numerical solution with the Kampmann-Wagner method so that the estimation of a change in an electroconductivity based on the change with time of the solid solution amount of each element in each of the precipitate and in a base phase approaches a change in an electroconductivity in a heat treatment experiment. The step 23 inputs the regulated interface energy to the simulation based on the Langer-Schwartz theory and the numerical solution with the Kampmann-Wagner method of estimating the change with time of the solid solution amount of Mg.

As described, the method of estimating a solid solution amount of Mg including the step 20 estimates the change with time of the solid solution amount of Mg in the aluminum alloy with the simulation with inputted more appropriate interface energy, and thereby the method can further improve the estimation accuracy.

### [Method of Producing Specimen]

Next, the method of producing a specimen will be described.

The method of producing a specimen is a method of producing a specimen with conservatively imitating (simulating) a change with time of a metallographic structure in the designed storage term of the aluminum alloy for a basket used for the metal cask.

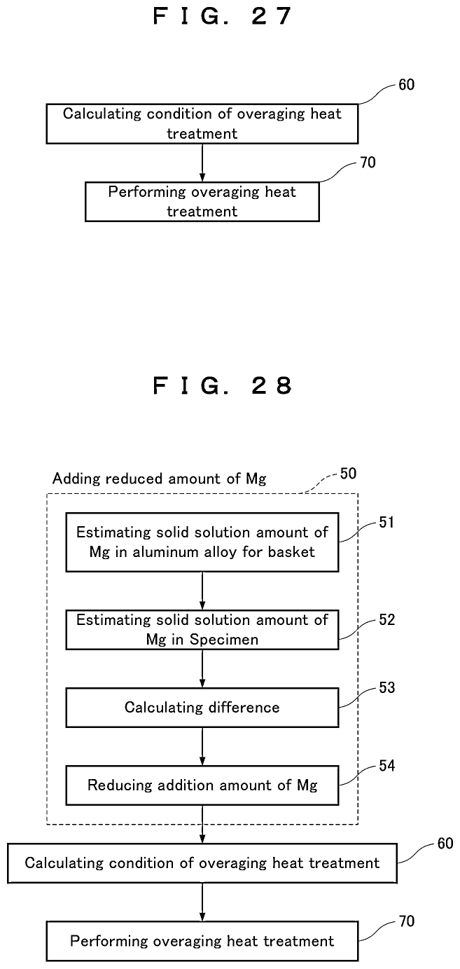

As indicated in FIG. 27, the method of producing a specimen includes: a step 60 of calculating a condition of an overaging heat treatment corresponding to a thermal history in the designed storage term of the aluminum alloy for a basket with the Larson-Miller equation using a constant obtained in a creep rupture test; and a step 70 of performing the overaging heat treatment on an aluminum alloy to be a base material of the specimen based on the calculated condition of the overaging heat treatment.

That is, the step 60 calculates the condition of the overaging heat treatment corresponding to the thermal history in the designed storage term of the aluminum alloy for a basket with the Larson-Miller equation. The Larson-Miller equation is as follows.

LMP=T×(logt+C)

LMP represents a Larson-Miller parameter.

T represents a temperature [° C.].

t represents a time [h].

C represents a material constant, specifically 14.

C=14 is obtained in the creep rupture test.

Then, the step 70 performs the overaging heat treatment on the aluminum alloy to be the base material of the specimen based on the condition of the calculated overaging heat treatment.

As described, the method of producing a specimen can imitate (simulate) the change with time of the metallographic structure in the designed storage term of the aluminum alloy for a basket used for the metal cask.

As indicated in FIG. 28, the method of producing a specimen may further include a step 50 of adding a reduced amount of Mg before the step 60.

The step 50 includes a step 51, a step 52, a step 53, and a step 54. The step 51 estimates a solid solution amount of Mg in an end stage of the designed storage term of the aluminum alloy for a basket with the method of estimating a solid solution amount of Mg. The step 52 estimates a solid solution amount of Mg in a stage corresponding to the end stage of the designed storage term of the specimen with the method of estimating a solid solution amount of Mg. The step 53 calculates a difference in a solid solution amount of Mg by subtracting the estimated solid solution amount of Mg in the aluminum alloy for a basket from the estimated solid solution amount of Mg in the specimen. The step 54 reduces an addition amount of Mg into an aluminum alloy to be a base material of the specimen by an amount of not less than the calculated difference of the solid solution amount of Mg.

As described, the method of producing a specimen including the step 50 can reduce the addition amount of Mg contributing to a solid-solution strengthening of the specimen. Therefore, the method can simulate the metallographic structure after the designed storage term of the aluminum alloy for a basket used for the metal cask.

### [Strength Evaluation Method]

Next, the strength evaluation method will be described.

The strength evaluation method evaluates a change with time of a material strength of the aluminum alloy for a basket used for the metal cask based on the specimen produced with the method of producing a specimen.

As described, the strength evaluation method is based on the specimen produced with the method of producing a specimen, and thereby the method can conservatively evaluate the change with time of the material strength of the aluminum alloy for a basket used for the metal cask.

### [Basis]

Hereinafter, a concept for the basis of the aforementioned contents and examples of simulations and experiments, etc. will be described. Hereinafter, for convenience, the aluminum alloy for a basket used for the metal cask is referred to as HZ-A3004-H112. In Tables and Drawings, HZ-A3004-H112 may be abbreviated as HZ-A3004. “Change in Strength of HZ-A3004-H112 in Designed Storage Term”

In spent fuel loaded in a cask, it is known that the calorific value decreases with attenuation of the decay heat, and the basket temperature drops from approximately 200° C. to approximately 100° C. from the initial stage to terminal stage of the designed storage term. The material property (metallographic structure) of HZ-A3004-H112 is considered to be changed by the heating in the designed storage term to deteriorate the strength. Therefore, investigated was the method of producing a specimen simulating the material strength of HZ-3004 after the designed storage term in order to appropriately evaluate the strength.

“Strengthening Mechanism”

The strengthening mechanism of HZ-A3004-H112 mainly includes the following four mechanisms.

(1) Dislocation Strengthening (work hardening): Processing increases a dislocation density to inhibit the movement of dislocation.

(2) Grain Refinement: Grains are refined to inhibit the movement of dislocation.

(3) Dispersion Strengthening: A dispersed phase finely precipitated in the base phase and distortion of an elastic crystal lattice generated around the dispersed phase with the precipitation inhibit the movement of dislocation. In HZ-A3004-H112, a Mn-based dispersed phase (Al₆Mn) mainly contributes to the dispersion strengthening.

(4) Solid-Solution Strengthening: Solid solution of atoms having a different size from metal atoms in the base phase distorts the around crystal lattice to inhibit the movement of dislocation. In HZ-A3004-H112, Mg mainly contributes to the solid-solution strengthening.

In order to appropriately evaluate the strength with considering the change in the material strength in the designed storage term, a method of simulating the change in the material property with each strengthening mechanism is required to be investigated to produce a specimen.

“Change in Material Property in Designed Storage Term”

Table 1 summarizes the strengthening mechanisms of HZ-A3004-H112. Investigated were a method of simulating the change in the material property when a metal material is held at high temperature for a long time, and the change in the material property of HZ-A3004-H112 after the designed storage term (60 years).

TABLE 1

| | | | Symbol | |
|---|---|---|---|---|
| | | | HZ-A3004 | |
| | | | Non-heat-treated alloy | |
| | | | Initial stage | Terminal stage in |
| | | | in designed | designed storage |
| Classification | | | storage term | term (after 60 years) |
| Strength- | (1) | Dislocation | Present | Absent |
| ening | | strengthening | | |
| mechanism | | (grain refinement) | | |
| | (2) | Grain refinement | Rolled | Recovery, |
| | | | structure | recrystallized |
| | | | | structure, or rolled |
| | | | | structure |
| | (3) | Dispersion | Al₆Mn | Al₆Mn |
| | | strengthening | Al₆(Fe, Mn) | Al₆(Fe, Mn) |
| | | with Mn-based | α-AlFeMnSi | α-AlFeMnSi |
| | | dispersed phase | | |
| | (4) | Solid-solution | Mg | Mg (reduced to |
| | | strengthening | | equilibrium solid |
| | | with Mg | | solution amount) |

(1) Dislocation Strengthening (Work hardening),
(2) Grain Refinement

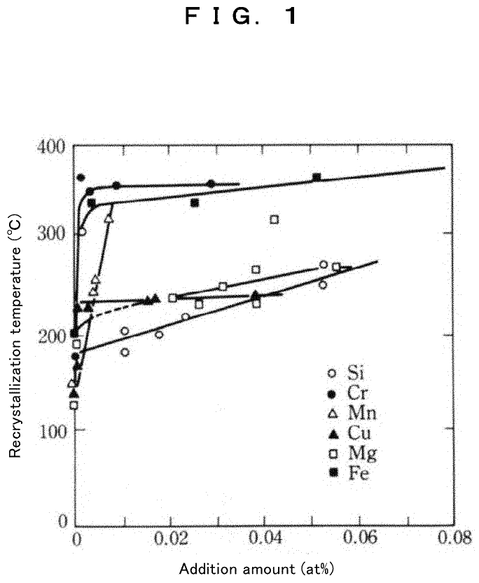

FIG. 1 shows influence of additive elements on a recrystallization temperature of aluminum. The source is Literature 1 “Structure and Property of Aluminum, published by The Japan Institute of Light Metals, (1991), pp. 160, 218, 222, 256”. Heating a metal material at high temperature for a long time causes a phenomenon of releasing distortion energy stored inside the grain with processing (recovery) to reduce the dislocation density, leading to a deteriorated material strength. In addition, new grains having no distortion is generated in the structure disorganized by processing, and the grains grow (recrystallize) to coarsened grains, leading to a deteriorated material strength. Meanwhile, presence of solid-solution atoms inhibits the movement of an interface by the dislocation and by an interaction with a sub-grain boundary to suppress the recrystallization. In a case of HZ-A3004-H112 containing approximately 1[mass %] of Mg, the recrystallization temperature rises to higher than 200° C. so that it is considered that recrystallization does not occur in the designed storage term.

Since being more likely to occur with retention at higher temperature for a longer time, the deterioration in strength of HZ-A3004-H112 with the reduced dislocation density and it is considered that the coarsened grains can be simulated by performing an overaging heat treatment equivalent to a thermal history in the designed storage term (60 years).

(3) Dispersion Strengthening with Mn-Based Dispersed Phase

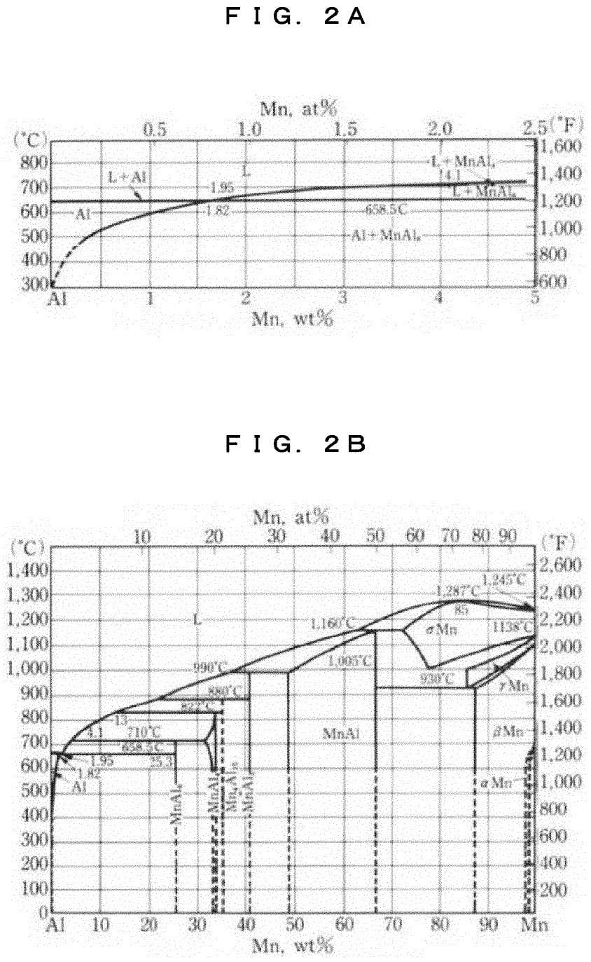

FIGS. 2A and B indicate a binary equilibrium diagram of Al-Mn. Mn hardly forms a solid solution in Al at 300° C. or lower, and is present as the second phase (such as Al₆Mn). Although the deterioration in strength with a reduced number density of the Mn-based dispersed phase is more likely to occur with retention at higher temperature, Mn forms a solid solution in Al at a temperature higher than 300° C. to fail to simulate the deterioration in strength. Therefore, it is considered that the deterioration in strength can be simulated by performing an overaging heat treatment equivalent to the thermal history of the designed storage term (60 years) at a temperature of 300° C. or lower.

(4) Solid-Solution Strengthening with Mg

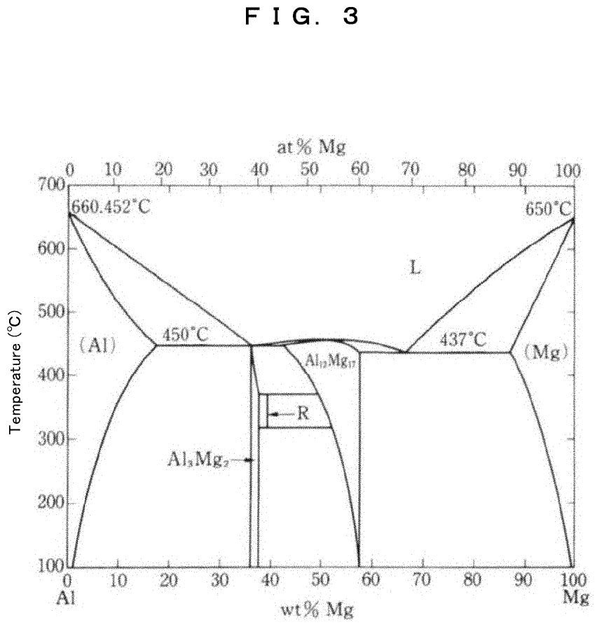

FIG. 3 indicates a binary equilibrium diagram of Al—Mg (see Literature 1). At a temperature of equal to or lower than an eutectic temperature (450° C.), the solid solution limit of Mg in Al reduces with temperature dropping.

Under the usage environment of the basket, it is considered that the solid solution limit of Mg is lowered by the temperature dropping in the designed storage term to deteriorate the material strength.

Meanwhile, the overaging heat treatment is performed at a higher temperature than a temperature during the storage, and the solid solution amount of Mg in the base phase increases to strengthen the material. Thus, with only the overaging heat treatment, the strength increases with the influence of the solid-solution strengthening of Mg to fail to simulate the solid solution amount of Mg in HZ-A3004-H112 after the designed storage term. In order to solve this problem, it is considered that the overaging heat treatment is performed on a material (specimen for the mechanical test) with a reduced addition amount of Mg from HZ-A3004-H112.

“Chemical Components in HZ-A3004-H112”

Table 2 shows specified values of chemical components in HZ-A3004-H112. HZ-A3004-H112 is a material based on the A3004 alloy specified in JIS H 4000, and having a narrowed range of specified components based on the following concepts.

Impurity Elements: The allowable values of the addition amount were set to be low within a manufacturable range with considering influences of the solid-solution strengthening and precipitation strengthening due to impurity elements.

Mn: The lower limit of the specified component range was set to be high with expecting the dispersion strength with the Mn-based dispersed phase.

Mg: The lower limit of the specified component range was set to be high with expecting the solid-solution strengthening with Mg.

TABLE 2

| Material | Specimen | Chemical components (mass %) | | | | | |
|---|---|---|---|---|---|---|---|
| name | symbol | Si | Fe | Cu | Mn | Mg | Zn |
| Specified values HZ- | | 0.15 or | 0.7 or | 0.05 or | 1.1- | 10- | 0.05 or |
| A3004 | | lower | lower | lower | 1.5 | 1.3 | lower |

| | | | | | | |
|---|---|---|---|---|---|---|
| (Reference) | 0.30 or | 0.7 or | 0.25 or | 1.0- | 0.8- | 0.25 or |
| JIS H 4000 A3004 | lower | lower | lower | 1.5 | 1.3 | lower |

“Simulation of Material Strength of HZ-A3004-H112 after Designed Storage Term”

A specimen (specimen for the mechanical test) simulating the material strength of HZ-A3004-H112 after the designed storage term was produced by reducing the addition amount of Mg into HZ-A3004-H112 and by performing the overaging heat treatment, and subjected to an evaluation test for the material property. Hereinafter, the summery of the overaging heat treatment and the reduction of the addition amount of Mg will be described.

(1) Overaging Heat Treatment

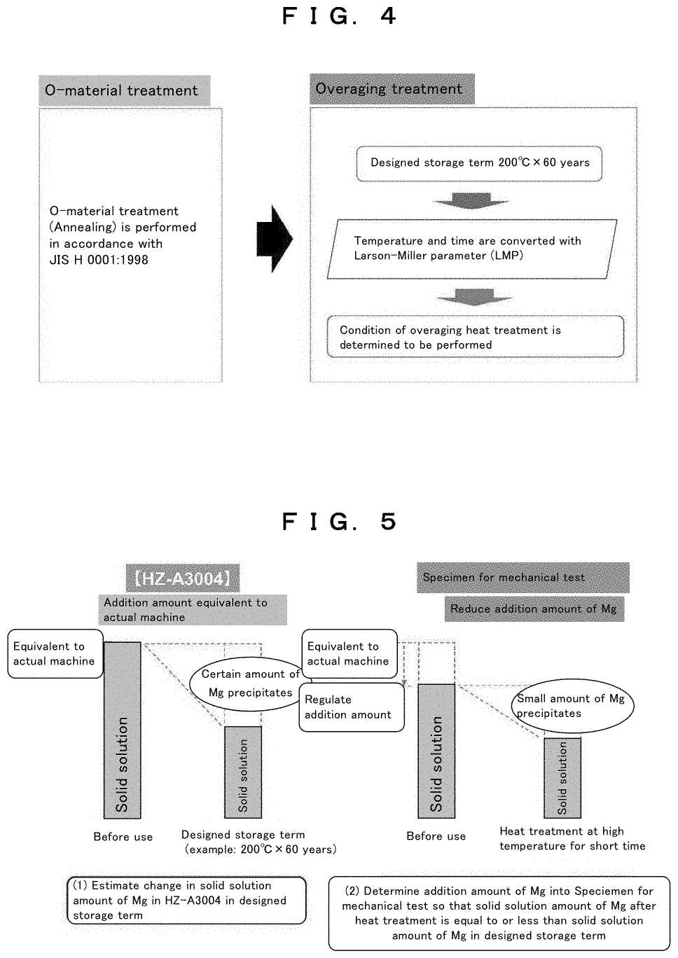

FIG. 4 indicates a schematic diagram of the overaging heat treatment. The overaging heat treatment simulated the reduction of a number density of the Mn-based dispersed phase, reduction of a dislocation density, and deterioration in strength due to coarsened grains, in HZ-A3004-H112 after the designed storage term.

As a condition of the overaging heat treatment, a condition of the overaging heat treatment equivalent to the thermal history in the designed storage term was determined by using the Larson-Miller parameter (LMP), one of time-temperature parameter methods.

Furthermore, an O-material treatment(annealed) in accordance with JIS H 0001:1998 was performed.

(2) Reduction of Addition Amount of Mg

FIG. 5 shows a schematic view relating to a method of determining an addition amount of Mg into the specimen for the mechanical test. A temperature of the overaging heat treatment is higher than a temperature in the designed storage term, and the solid solution amount of Mg in the overaging-treated HZ-A3004-H112 increases. Since the increase in the solid solution amount of Mg contributes to the solid-solution strengthening, the strength cannot be conservatively evaluated. The designed storage term is as long as 60 years, and thereby it is difficult to experimentally perceive the solid solution amount of Mg after the use.

Thus, a change in the solid solution amount of Mg in 60 years was calculated with a metallographic structure simulation. The procedure is as follows: calculating the change in the solid solution amount of Mg in HZ-A3004-H112 in the designed storage term; and determining an addition amount of Mg into a specimen for the mechanical test so as to be able to conservatively simulate the solid solution amount of Mg in HZ-A3004-H112 after the heat treatment and subsequent designed storage term.

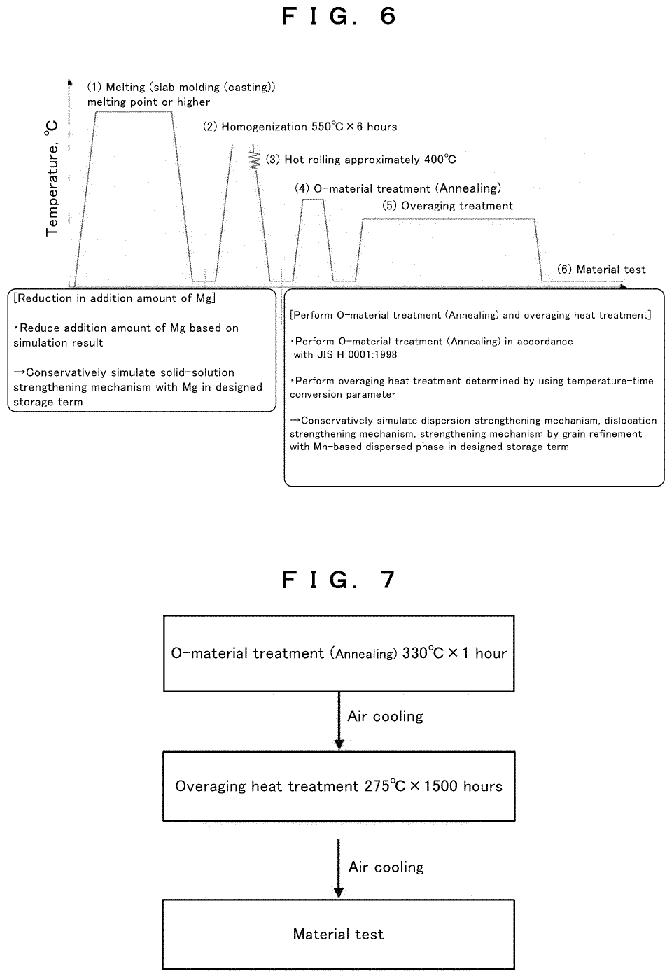

FIG. 6 indicates a method of producing a specimen for a mechanical test summarizing the aforementioned (1) and (2). Details of a method of simulating a change in the material property will be described after the next “Heat Treatment Condition”.

“Heat Treatment Condition”

(1) O-Material Treatment (Annealing)

The basket material, a material of HZ-A3004-H112, was subjected to the O-material treatment to conservatively evaluate the strength (a cooling condition after the retention was air-cooling).

(2) Overaging Heat Treatment

A condition of an overaging heat treatment conservatively equivalent to the thermal history in the designed storage term was investigated by using the Larson-Miller parameter (LMP). The LMP is given by the following equation.

LMP=T×(logt+C)

Here, t represents a time [h], T represents a temperature [°C.], and C represents a material constant (14). The value of the material constant C was set to 14 with reference to a value from a test performed by Japan Nuclear Energy Safety Organization.

The thermal history in the designed storage term was set to 200° C.×60 years with conservatively considering influence of diffusion of the constituent elements generated in the aluminum base phase.

Mn hardly forms a solid solution in Al at 300° C. or lower. The temperature of the overaging heat treatment was selected within a range of 200° C. to 300° C. so that states of the solid solution and precipitation of Mn become equivalent to the designed storage term (approximately 200° C. to 100° C.).

Table 3 shows the investigation results of an equivalent retention time on each heat treatment temperature with respect to the thermal history in the designed storage term. With respect to the thermal history in the designed storage term (200° C.×60 years), for example, the equivalent retention time is 1054 hours in an overaging heat treatment at 275° C. Thus, the overaging heat treatment temperature was set to 275° C., and the overaging heat treatment time was set to 1500 hours with a safety factor of 1054 hours. The condition of the overaging heat treatment is shown below.

Example of condition of overaging heat treatment: 275° C.×1500 hours

TABLE 3

| | Equivalent retention time at each overaging heat | | | | | |
|---|---|---|---|---|---|---|
| Thermal history of | treatment temperature | | | | | |
| designed storage term | 200° C. | | 225° C. | 250° C. | 275° C. | 300° C. |
| 200° C. × 60 years | 60 | years | 53,857 hours | 6,857 hours | 1,054 hours | 191 hours |
| (Reference) 200° C. → | 64,212 | hours | 7,308 hours | 1,024 hours | 172 hours | 34 hours |
| 100° C. × 60 years | | | | | | |

Table 3 also shows, as a reference, the investigation results when 200° C.→100° C.×60 years (60 years with constant temperature drop from 200° C. to 100° C.) is assumed with considering a temperature drop in the designed storage term. In this case of 200° C.→100° C.×60 years, the equivalent retention time at 275° C. with respect to the designed storage term is 172 hours. The overaging heat treatment time of 1500 hours is sufficiently conservative value.

The sufficiently conservative condition of the overaging heat treatment is not limited to the aforementioned 275° C.×1500 hours, and may be 201° C.×55 years to 300° C.×191 hours.

FIG. 7 shows the condition of the heat treatment of the specimen for the mechanical test.

“Investigation of Addition Amount of Mg”

<1. Summary of Simulation>

In order to calculate the metallographic structure, particularly the solid solution amount of Mg, in HZ-A3004-H112 after the designed storage term, a software for thermodynamic equilibrium calculation (Thermo-Calc) and a module for precipitation calculation (TC-Prisma) were used. The summary of the simulation software will be described below.

Thermo-Calc is based on “CALPHAD method” using a thermodynamic database of experimental results and a thermodynamic theory to prepare an equilibrium diagram, and is an integrated software for thermodynamic calculation that can calculate thermodynamic quantities such as the equilibrium diagram in a multi-component system. Although Thermo-Calc alone can investigate only the equilibrium theory, use in combination with TC-Prisma subroutine can perform a kinetic simulation with considering the kinetic theory (time cause). On Thermo-Calc described herein, the developer is “Thermo-Calc Software AB”, a software version is “Thermo-Calc 2021b”, a used database is “TCAL6”, and the URL is “https://thermocalc.com/products/thermo-calc/” (accessed on Sep. 8, 2021).

TC-Prisma, a module for precipitation calculation attached to Thermo-Calc, can calculate nucleation, growth, and enlarging of a precipitate under any heat treatment condition on a multi-component or a multi-phase alloy system. TC-Prisma performs the calculation with the Langer-Schwartz (LS) theory and the numerical solution with the Kampmann-Wagner (KWN) method. The KWN method solves a time development equation using the nucleation theory, a growth rate model, and a particle diameter distribution on the LS theory to calculate a change with time of the phase diagram with considering nucleation, growth, enlarging, and the like of the precipitate. Inputting an alloy component, retention temperature and time, and the like enables to output changes with time of a solid solution amount of a solute element, volume fraction of the precipitate, and the like in the base phase. On TC-Prisma described herein, the developer is “Thermo-Calc Software AB”, a used database is “MOBALS”, and the URL is “https://thermocalc.com/products/add-on-modules/precipitation -module-tc-prisma/” (accessed on September 8, 2021). It is to be noted that TC-Prisma has no version because TC-Prisma is an add-on module of Thermo-Calc.

The Langer-Schwartz (LS) theory is sourced from “J. S. Langer, et al., “Kinetics of nucleation in near-critical fluids”, Phys. Rev., A21 (1980), p. 948”. The numerical solution with the Kampmann-Wagner (KWN) method is sourced from “R. Wagner, et al., “Homogeneous second-phase precipitation”, G. Kostorz (Ed.), Phase tranformations in materials, Wiley-VCH, New York (NY) (2001), p. 309”.

Determining the addition amount of Mg into the specimen for the mechanical test requires investigation of a change with time of a solid solution amount of Mg in the designed storage term. In this section, Thermo-Calc and TC-Prisma are used. The solid solution amount of Mg in HZ-A3004-H112 after the designed storage term was calculated with the following procedure.

(1) An equilibrium diagram was prepared with the simulation with the equilibrium theory using Thermo-Calc to estimate a precipitate generated in HZ-A3004-H112.

(2) A change in a solid solution amount of Mg in HZ-A3004-H112 in the designed storage term was estimated with the simulation with the kinetic theory using TC-Prisma.

(3) An addition amount of Mg into the specimen for the mechanical test was estimated so that the solid solution amount of Mg after the heat treatment is lower than the solid solution amount of Mg in HZ-A3004-H112 after the designed storage term.

<2. Validation of Simulation>

The simulation software Thermo-Calc and TC-Prisma were validated, and the validation method is as follows. With respect to literature investigating a change in a solid solution amount of elements with heating an aluminum alloy, a simulation of a thermal history was performed on the same alloy component to validate the integrity of the results. Further, the heat treatment test and the simulation were performed on HZ-A3004-H112 to validate the integrity.

(1) Validation with Literature

A simulation was performed with the same chemical components under the same heat treatment condition as in Literature 2 “Nakayama et al., Journal of Japan Institute of Light Metals, Volume 60, Issue 2, (1996), pp. 135-140”, targeting an Al-Mg-based A5083 material, to validate the integrity of the results.

(1-a) Validation Method

(i) Table 4 shows the chemical components of the specimen subjected to the test in Literature 2. An equilibrium diagram of the specimen (A5083) was calculated by using Thermo-Calc to estimate a precipitate generated in the specimen.

TABLE 4

| | Chemical components (mass %) | | | | | | | | |
|---|---|---|---|---|---|---|---|---|---|
| | Si | Fe | Cu | Mn | Mg | Zn | Cr | Ti | Al |
| Specimen | 0.14 | 0.19 | 0.03 | 0.69 | 4.68 | 0.01 | 0.08 | 0.01 | Remainder |
| (Reference) | 0.40 or | 0.40 or | 0.10 or | 0.40- | 4.0- | 0.25 or | 0.05- | 0.15 or | Remainder |
| JIS H4000 | lower | lower | lower | 1.00 | 4.9 | lower | 0.25 | lower | |
| A5083 | | | | | | | | | |

(ii) A change in volume fractions of the precipitate and a change in a solid solution amount of Mg in the specimen under the heat treatment condition (180° C.×3000 hours) were calculated by using TC-Prisma.

(iii) A simulation parameter (interface energy γ [J/m²] between the aluminum base material and the precipitate) was fitted by using the measured value in Literature 2.

Here, the interface energy γ [J/m²] is energy to be a deterrent to phase decomposition when a supersaturated solid solution having an average composition of C₀ causes phase separation into compositions C₁ and C₂. The interface energy depends on a boundary structure between different phases (such as the metal in the base phase and the precipitate) and the like, and determines energy required for nucleation of the second phase in the base phase. Regulating the interface energy on each precipitate enables to obtain simulation results integrated with the measured values on the phenomenon of the change in a material property with the precipitate generation.

(1-b) Validation Result

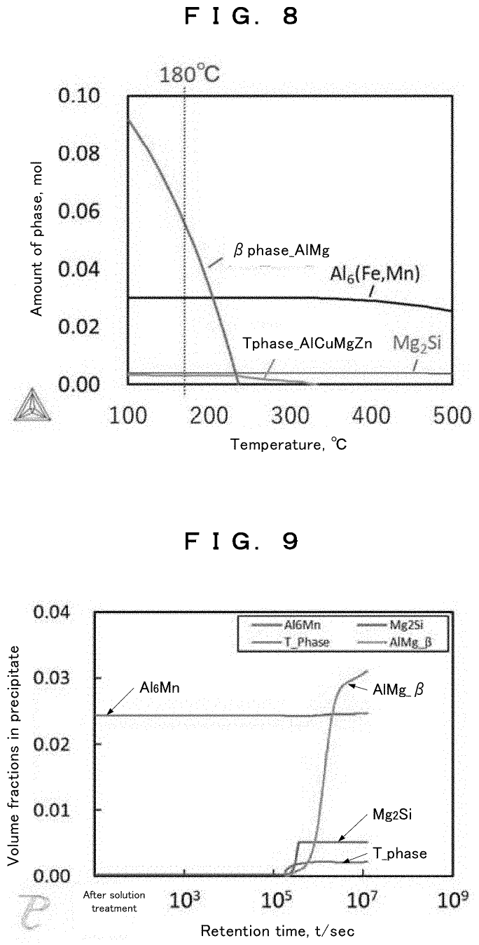

FIG. 8 indicates the equilibrium diagram of the specimen (A5083) calculated by using Thermo-Calc. In the equilibrium state, precipitates of Al₆(Fe,Mn), Mg₂Si, β-phase_AlMg, and T-phase_AlCuMgZn are generated.

Table 5 indicates a condition of the interface energy γ used for the simulation. The interface energies of Al₆(Fe,Mn) and Mg₂Si were regulated to integrate the simulation result with the experiment result.

TABLE 5

| Type of precipitated phase | Interface energy γ [J/m²] |
|---|---|
| Al₆ (Fe, Mn) | 6.54 × 10⁻⁹ × (T + 273) + 0.0574 |
| Mg₂Si | −8.13 × 10⁻⁶ × (T + 273) + 0.2885 |
| β Phase_AlMg | Default value of simulation software |
| T Phase_AlMgCuZn | Default value of simulation software |

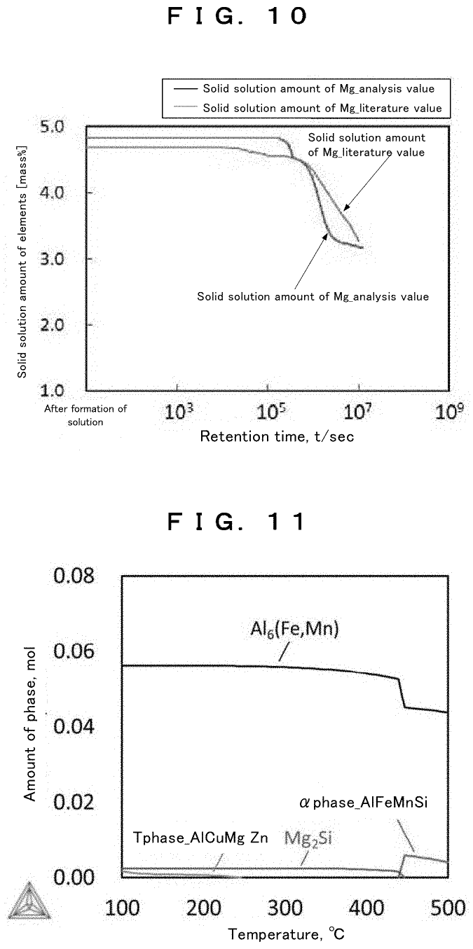

FIG. 9 shows the result of the change in volume fractions of the precipitate with the heat treatment of the specimen, calculated by TC-Prisma. FIG. 10 shows the calculated results of the change in the solid solution amount of Mg. When the specimen formed the solid solution and was subsequently heat-treated at 180° C., the volume fraction of the β-phase rapidly increased after retention in 10⁶ seconds to decrease the solid solution amount of Mg. This simulation result found that the retention time generating the Mg precipitate and the absolute value of the solid solution amount of Mg approximately coincided with the report in Literature 2.

(2) Validation with HZ-A3004-H112

HZ-A3004-H112 was heat-treated, and a simulation under the same condition was performed to validate the integrity of the result.

(2-a) Experiment Method

Table 6 shows the chemical components in the specimen. The specimen was subjected to a solid-solution treatment at 500° C. for 2 hours, and quenched in water. Further, an aging treatment at 200° C. for maximum 3000 hours to measure a change in an electroconductivity. The electroconductivity was measured by using a conductivity meter (SIGMASCOPE SMP350, manufactured by FISCHER INSTRUMENTS K.K.) as IACS% (ratio of electroconductivity based on pure copper).

TABLE 6

| | Chemical components (mass %) | | | | | | |
|---|---|---|---|---|---|---|---|
| | Si | Fe | Cu | Mn | Mg | Zn | Al |
| Specimen | 0.09 | 0.36 | 0.02 | 1.43 | 1.20 | 0.01 | Remainder |
| HZ-A3004 (test | | | | | | | |
| piece B) | | | | | | | |
| (Reference) | 0.30 or | 0.7 or | 0.25 or | 1.0- | 0.8- | 0.25 or | Remainder |
| JIS H4000 | lower | lower | lower | 1.5 | 1.3 | lower | |
| A3004 | | | | | | | |

(2-b) Validation Method

(i) An equilibrium diagram of the specimen (HZ-A3004-H112) was calculated by using Thermo-Calc to estimate a precipitate to be generated.

(ii) Calculated by using TC-Prisma were the change in volume fractions of the precipitate and the change in solid solution amounts of additive elements under the heat treatment condition (formation of solution 200° C.×3000 hours).

(iii) Table 7 shows influence of the additive elements on the electroconductivity of the Al alloy (see Literature 1). The electroconductivity of the Al alloy depends on amounts of the additive elements forming a solid solution or being precipitated in the alloy. Based on the simulation results, the electroconductivity was calculated using Table 7.

TABLE 7

| | | Averaged increase in specific resistance* | |
|---|---|---|---|
| | Maximum degree of | (μΩ-cm/%) | |
| Element | solid solution (%) | Solid solution | Precipitate |
| Cr | 0.77 | 4.00 | 0.18 |
| Cu | 5.65 | 0.344 | 0.030 |
| Fe | 0.052 | 2.56 | 0.058 |
| Li | 4.0 | 3.31 | 0.68 |
| Mg | 14.9 | 0.54 | 0.22 |
| Mn | 1.82 | 2.94 | 0.34 |
| Ni | 0.05 | 0.81 | 0.061 |
| Si | 1.65 | 1.02 | 0.088 |
| Ti | 1.0 | 2.88 | 0.12 |
| V | 0.5 | 3.58 | 0.28 |
| Zn | 82.8 | 0.094 | 0.023 |
| Zr | 0.28 | 1.74 | 0.044 |

(iv) An interface energy γ [J/m²] of the precipitate was fitted so that the simulation result was integrated with the experiment result.

(2-c) Validation Result

FIG. 11 indicates the equilibrium diagram of the specimen (HZ-A3004-H112) calculated by using Thermo-Calc. In the equilibrium state, Al₆(Fe,Mn), α-AlFeMnSi, Mg₂Si, and T-phase_AlCuMgZn are generated.

Table 8 shows the condition of the interface energy y used for the simulation. Fitting the interface energies of Al₆(Fe,Mn) and Mg₂Si yielded simulation results integrated with the experiment result.

TABLE 8

| Type of precipitated phase | Interface energy γ [J/m²] |
|---|---|
| Al₆ (Fe, Mn) | 2.33 × 10⁻⁹ × (T + 273)² − 2.40 × |
| | 10⁻⁶ × (T + 273) × +0.0557 |
| α-AlFeMnSi | Default value of simulation software |
| Mg₂Si | −9.05 × 10⁻⁶ × (T + 273) + 0.2690 |
| T Phase_AlMgCuZn | Default value of simulation software |

On Al₆(Fe,Mn), the default values in Thermo-Calc were plotted on an interface energy-temperature graph, and the plotted graph was approximated to a quadratic function of temperature. This procedure approximated (simplified) the interface energy to the quadratic function. On Mg₂Si, the default values in Thermo-Calc were plotted on an interface energy-temperature graph, and the plotted graph was approximated to a linear function of temperature, and in addition, the intercept was changed into a direction of higher interface energy. These approximation (simplification) of the interface energy and the change of the intercept can integrate the simulation result with the experiment result.

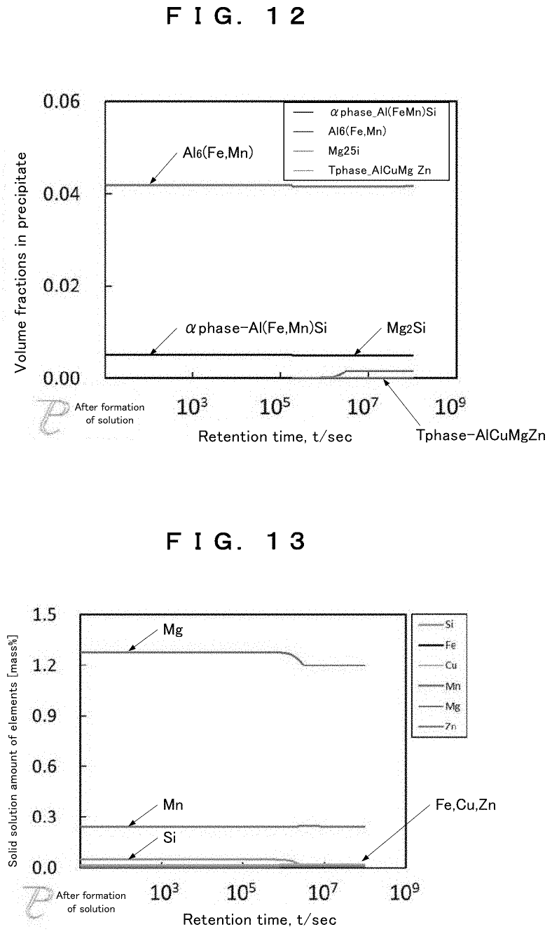

FIG. 12 shows the change in the volume fractions in the precipitate, and FIG. 13 shows the calculated result of the change in the solid solution amount of Mg. When the specimen formed the solid solution and was subsequently heat-treated at 200° C., the volume fraction of the Mg₂Si phase increased after retention in 10⁶ seconds to decrease the solid solution amount of Mg.

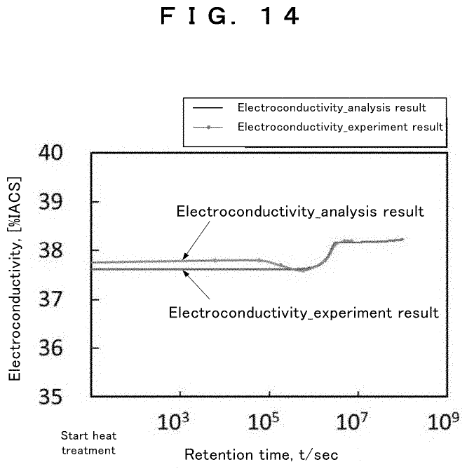

FIG. 14 shows the result of the calculated electroconductivity from the simulation result and compared with the experiment result. The retention time and change in an amount influenced on the electroconductivity approximately coincided with the experiment results.

From the aforementioned investigations (1) and (2), it was judged that applying the simulation using Thermo-Calc and TC-Prisma enabled to calculate the solid solution amount of Mg in HZ-A3004-H112 after the designed storage term.

<3. Investigation of Addition Amount of Mg into Specimen for Mechanical Test>

(1) Summary

A solid solution amount of Mg in HZ-A3004-H112 after the designed storage term was calculated with the simulation, and an addition amount of Mg into the specimen for the mechanical test was investigated.

(2) Simulation Method

(i) Table 9 shows chemical components used for the simulation of the change in the solid solution amount of Mg in HZ-A3004-H112. An equilibrium diagram in HZ-A3004-H112 was calculated to estimate a precipitate to be generated.

TABLE 9

| | Chemical components (mass %) | | | | | | |
|---|---|---|---|---|---|---|---|
| | Si | Fe | Cu | Mn | Mg | Zn | Al |
| HZ-A3004 Simulation | 0.15 | 0.7 | 0.05 | 1.1 | 1.0 | 0.05 | Remainder |
| composition of | | | | | | | |
| specified values | | | | | | | |
| Specified value | 0.15 or | 0.7 or | 0.05 or | 1.1- | 1.0- | 0.05 or | Remainder |
| HZ-A3004 | lower | lower | lower | 1.5 | 1.3 | lower | |
| (Reference) | 0.30 or | 0.7 or | 0.25 or | 1.0- | 0.8- | 0.25 or | Remainder |
| JIS H4000 | lower | lower | lower | 1.5 | 1.3 | lower | |
| A3004 | | | | | | | |

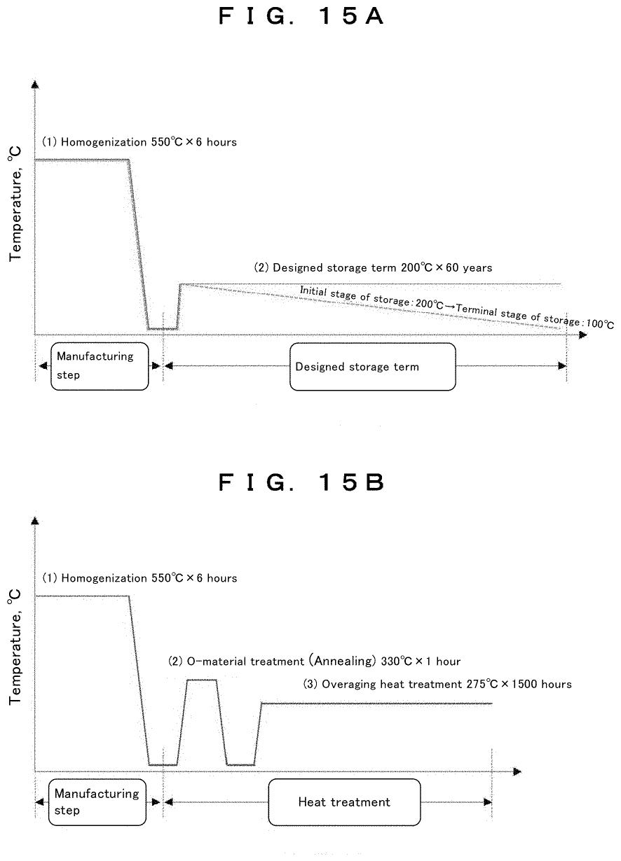

(ii) Table 10 shows the interface energy γ of the precipitate used for the simulation. Used as the interface energy γ of the precipitate was the value in Table 8 validating HZ-A3004-H112 in the aforementioned “(2) Validation with HZ-A3004-H112”. Thus, Table 10 is same as Table 8. FIGS. 15A and B show the heating conditions in the designed storage term and in the heat treatment. The simulation was performed under these conditions to determine the change in the solid solution amount of Mg in HZ-A3004-H112 in the designed storage term.

TABLE 10

| Type of precipitated phase | Interface energy γ [J/m²] |
|---|---|
| Al₆ (Fe, Mn) | 2.33 × 10⁻⁹ × (T + 273)² − 2.40 × |
| | 10⁻⁶ × (T + 273) × +0.0557 |
| α-AlFeMnSi | Default value of simulation software |
| Mg₂Si | −9.05 × 10⁻⁶ × (T + 273) + 0.2690 |
| T Phase_AlMgCuZn | Default value of simulation software |

(iii) A solid solution amount of Mg after the heat treatment (275° C.×1500 hours) was determined with the simulation, and the addition amount of Mg into the specimen for the mechanical test was investigated so as to be lower than the value of HZ-A3004-H112 after the designed storage term.

(3) Simulation Result

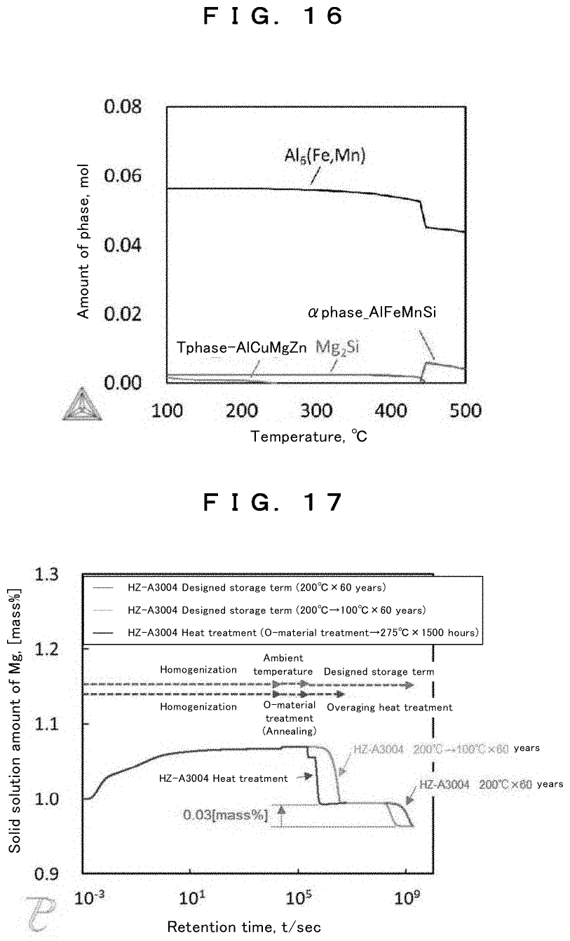

FIG. 16 shows the estimated result of the equilibrium diagram of HZ-A3004-H112. In the equilibrium state, Al₆(Fe,Mn), α-Al₆(FeMnSi, Mg₂Si, and T-phase_AlCuMgZn are generated.

FIG. 17 shows the calculated result of the change in the solid solution amount of Mg in HZ-A3004-H112 in the designed storage term and in the heat treatment.

When the heat retention of the designed storage term was performed on HZ-A3004-H112, the solid solution amount of Mg added at 1.00 [mass %] reduced to approximately 0.962 [mass %] after the retention. Meanwhile, the solid solution amount of Mg in HZ-A3004-H112 subjected to the heat treatment of 275° C.×1500 hours was approximately 0.995 [mass %], and was higher than the value in HZ-A3004-H112 after the designed storage term by approximately 0.03 [mass %].

Thus, the addition amount of Mg into the specimen for the mechanical test was set to 0.95 [mass %], lowered than HZ-A3004-H112 by 0.05 [mass %], to perform the simulation.

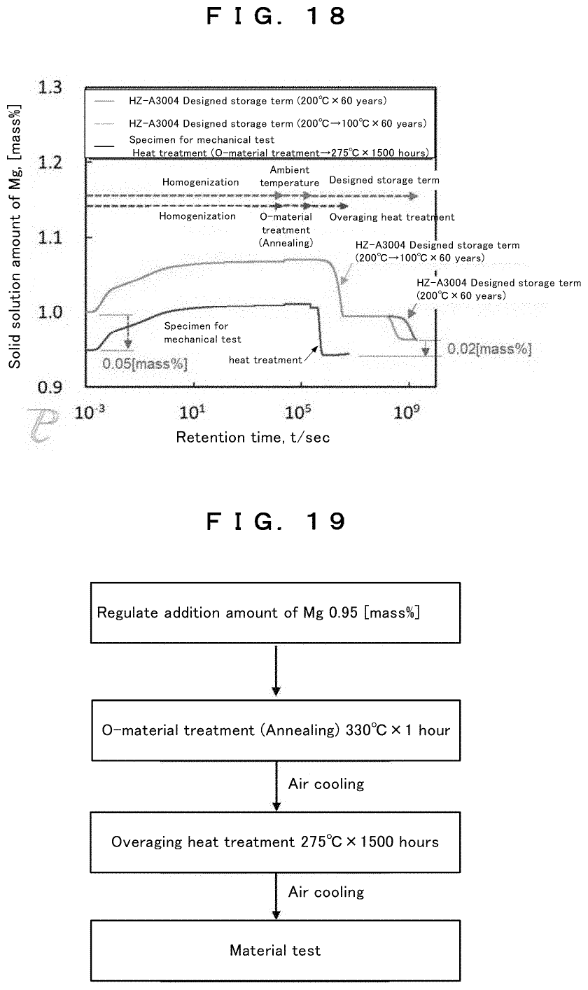

FIG. 18 and Table 11 show the calculated result of the change in the solid solution amount of Mg with the heat treatment of the specimen for the mechanical test. When the specimen for the mechanical test was heat-treated, the solid solution amount of Mg after the retention was approximately 0.945 [mass %]. This result was lower than the result of the simulation on HZ-A3004-H112 after the designed storage term by approximately 0.02 [mass %].

TABLE 11

| | | | Change in solid | |
|---|---|---|---|---|
| | | | solution amount of Mg | |
| Material | | | Initial | After |
| name | Heating condition | | stage | heating |
| HZ-A3004 | Designed | 200° C. × 60 years | 1.00 | 0.962 |
| | storage term | 200° C. → 100° | 1.00 | 0.963 |
| | | C. × 60 years | | |
| | Heat | O-material treatment | 1.00 | 0.995 |
| | treatment | (Annealing) → | | |
| | | 275° C. × | | |
| | | 1500 hours | | |
| Specimen for | Heat | O-material treatment | 0.95 | 0.945 |
| mechanical | treatment | (Annealing) → | | |
| test | | 275° C. × | | |
| | | 1500 hours | | |

From the aforementioned investigation, it is considered that setting the addition amount of Mg into the specimen for the mechanical test to 0.95 [mass %] and performing the O-material treatment(annealing) and the overaging heat treatment can conservatively simulate the material strength of HZ-A3004-H112 after the designed storage term.

FIG. 19 shows the production condition of the specimen for the mechanical test. The specimen produced under the condition in FIG. 19 was specified as a material simulating the material strength of HZ-A3004-H112 after the designed storage term, and subjected to an evaluation test for the material property.

“Evaluation Test for Material Property”

“Specimen”

Table 12 shows the produced specimen. With considering the investigation result of the aforementioned “Change in Strength of HZ-A3004-H112 in Designed Storage Term”, the addition amount of Mg into the specimen for the mechanical test was set to 0.95 [mass %]. The chemical components in HZ-A3004-H112 and in the specimen for the mechanical test are within a range of the specified value. All of the three produced test pieces of the specimen for the mechanical test have the addition amount of Mg of near 0.95 [mass %], target value. The addition amount of Mg into the specimen for the mechanical test is not limited to the values shown in Table 12, and may be any as long as the addition amount is lower than the addition amount of Mg into HZ-A3004-H112 by 0.05 or more [mass %]. For example, when the addition amount of Mg into HZ-A3004-H112 is 1.00 to 1.30 [mass %], the upper limit of the addition amount of Mg into the specimen for the mechanical test is 0.95 to 1.25 [mass %]. The lower limit of the addition amount of Mg into the specimen for the mechanical test is 0.80 [mass %].

TABLE 12

| | Specimen | Chemical components (mass %) | | | | | |
|---|---|---|---|---|---|---|---|
| Material name | symbol | Si | Fe | Cu | Mn | Mg | Zn |
| HZ-A3004 | A | 0.08 | 0.36 | 0.02 | 1.28 | 1.11 | 0.01 |
| | B | 0.09 | 0.38 | 0.02 | 1.27 | 1.16 | 0.01 |
| | C | 0.09 | 0.36 | 0.02 | 1.43 | 1.20 | 0.01 |
| Specimen for | D | 0.09 | 0.38 | 0.01 | 1.31 | 0.93 | 0.01 |
| mechanical | E | 0.08 | 0.37 | 0.01 | 1.27 | 0.95 | 0.01 |
| test | F | 0.08 | 0.37 | 0.01 | 1.29 | 0.96 | 0.01 |

| | | | | | | |
|---|---|---|---|---|---|---|
| Specified value HZ-A3004 | 0.15 or | 0.7 or | 0.05 or | 1.1- | 1.0- | 0.05 or |
| | lower | lower | lower | 1.5 | 1.3 | lower |
| Specified value Specimen for | 0.15 or | 0.6 or | 0.05 or | 1.1- | 0.80- | 0.05 or |
| mechanical test | lower | lower | lower | 1.5 | 1.10 | lower |
| (Reference) JIS H 4000 A3004 | 0.30 or | 0.7 or | 0.25 or | 1.0- | 0.8- | 0.25 or |
| | lower | lower | lower | 1.5 | 1.3 | lower |

On the produced specimen, the simulation of the heating in the designed storage term and the overaging heat treatment was performed to validate the addition amount of Mg.

(1) Change in Solid Solution Amount of Mg in Specimen (1-a) Investigation Method

(i) Table 13 shows the simulation composition. On both of HZ-A3004-H112 and the specimen for the mechanical test, the simulation compositions targeted the components in a mill test certificate of the specimen. Table 14 shows the interface energy y of the precipitate used for the simulation. Used as the interface energy y of the precipitate was the value in Table 8 for the validation. Thus, Table 14 is same as Table 8. Used as the heating conditions in the designed storage term and in the heat treatment were the values in FIGS. 15A and B.

TABLE 13

| | Chemical components (mass %) | | | | | | |
|---|---|---|---|---|---|---|---|
| Material name | Si | Fe | Cu | Mn | Mg | Zn | Al |
| HZ-A3004 | 0.08 | 0.36 | 0.02 | 1.27 | 1.11 | 0.01 | Remainder |
| Specimen for | 0.08 | 0.35 | 0.01 | 1.27 | 0.93 | 0.01 | Remainder |
| mechanical test | | | | | | | |

TABLE 14

| Type of precipitated phase | Interface energy γ [J/m²] |
|---|---|
| Al₆ (Fe, Mn) | 2.33 × 10⁻⁹ × (T + 273)² − |
| | 2.40 × 10⁻⁶ × (T + 273) × +0.0557 |
| α-AlFeMnSi | Default value of simulation software |
| Mg₂Si | −9.05 × 10⁻⁶ × (T + 273) + 0.2690 |
| T Phase_AlMgCuZn | Default value of simulation software |

(ii) An amount of decrease in the solid solution amount of Mg in the heat-treated specimen for the mechanical test was determined to be compared with the aforementioned (i).

(1-b) Investigation Results

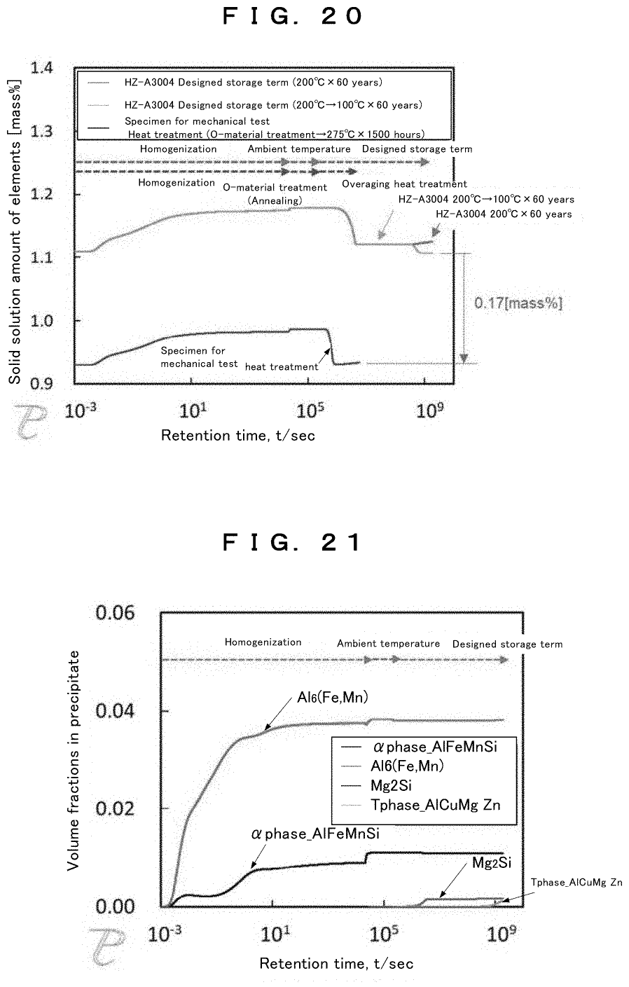

FIG. 20 shows the calculated results of the change in the solid solution amount of Mg of the specimen with respect to the components in the mill test certificate. Heat retention of the designed storage term on HZ-A3004-H112 results in the solid solution amount of Mg after the retention of approximately 1.107 [mass %]. Meanwhile, the solid solution amount of Mg in the heat-treated specimen for the mechanical test is approximately 0.934 [mass %]. Thus, it is considered that the solid-solution strengthening of Mg in HZ-A3004-H112 after the designed storage term can be conservatively simulated.

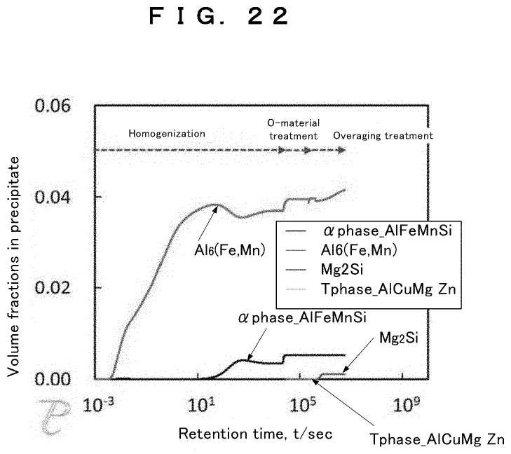

FIG. 21 and FIG. 22 show the calculated results of the change in volume fractions of the precipitate. No difference is observed between types of the precipitates generated in HZ-A3004-H112 and in the specimen for the mechanical test, and the amounts of the precipitate after the retention approximately coincides with each other. It is considered that the dispersion strengthening with the Mn-based dispersed phase in HZ-A3004-H112 after the designed storage term is also simulated.

From the aforementioned investigation, it is considered that performing the heat treatment on the produced specimen for the mechanical test can simulate the material strength of HZ-A3004-H112 after the designed storage term.

“Results of Evaluation Test for Material Property”

The strength property was evaluated by using HZ-A3004-H112 (initial material) and the specimen for the mechanical test (heat-treated material).

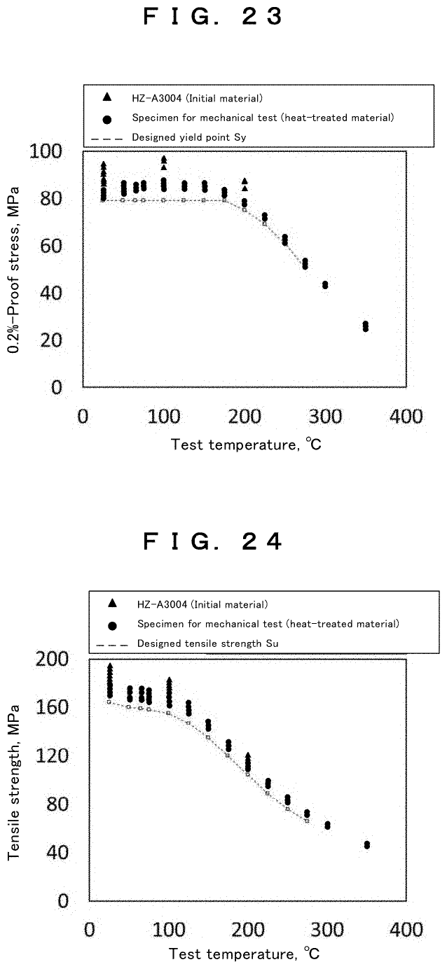

FIG. 23 and FIG. 24 show results of a tensile test of HZ-A3004-H112 (initial material) and the specimen for the mechanical test (heat-treated material) at each test temperature.

Table 15 and Table 16 summarize the results of the tensile test. Tables 17 to 20 shows the test data.

TABLE 15
Relationship between test temperature and 0.2%-proof stress [MPa]

| | | Test temperature | | |
|---|---|---|---|---|
| | | Ambient | | |
| Material | | temperature | 100° C. | 200° C. |
| (1) HZ-A3004 | (initial | 90.8 | 95.1 | 86.0 |
| | material) | | | |
| (2) Specimen for | (heat-treated | 82.2 | 86.0 | 78.1 |
| mechanical test | material) | | | |

| | | | |
|---|---|---|---|
| Difference between (1) and (2) | 8.6 | 9.1 | 7.9 |

TABLE 16
Relationship between test temperature and tensile strength [MPa]

| | | Test temperature | | |
|---|---|---|---|---|
| | | Ambient | | |
| Material | | temperature | 100° C. | 200° C. |
| (1) HZ-A3004 | (initial | 186.3 | 177.9 | 115.8 |
| | material) | | | |
| (2) Specimen for | (heat-treated | 172.9 | 166.1 | 111.0 |
| mechanical test | material) | | | |

| | | | |
|---|---|---|---|
| Difference between (1) and (2) | 13.4 | 11.8 | 4.8 |

TABLE 17

| | | L direction | | | T direction | | |
|---|---|---|---|---|---|---|---|
| | Test | 0.2%-Proof | Tensile | | 0.2%-Proof | Tensile | |
| Specimen | temperature | stress | strength | Elongation | stress | strength | Elongation |
| symbol | [° C.] | [MPa] | [MPa] | [%] | [MPa] | [MPa] | [%] |
| A | 25 | 88 | 187 | 23 | 90 | 181 | 21 |
| | 25 | 88 | 186 | [symbol] | 90 | 182 | 21 |
| | 25 | 88 | 188 | 22 | 90 | 180 | 20 |
| | 25 | 87 | 186 | 23 | 90 | 181 | 20 |
| | 25 | 86 | [symbol] | 22 | 90 | 181 | 20 |
| | 25 | 87 | 186 | 23 | 90 | 181 | 21 |
| | 100 | | | | 93 | [symbol] | 22 |
| | 100 | | | | 93 | 176 | 22 |
| | 100 | | | | 93 | 176 | 20 |
| | 200 | | | | [symbol] | 114 | 63 |
| | 200 | | | | 84 | 115 | 58 |
| | 200 | | | | 84 | 114 | 60 |
| B | 25 | 90 | 188 | 22 | 94 | 184 | 21 |
| | 25 | 91 | 187 | 22 | 94 | 184 | 20 |
| | 25 | 90 | 186 | 22 | 94 | 186 | 20 |
| | 25 | 90 | 187 | 22 | 94 | 183 | 20 |
| | 25 | 90 | 186 | 22 | 94 | 185 | 20 |
| | 25 | 91 | 186 | 22 | 94 | 184 | 21 |
| | 100 | | | | 96 | 178 | 20 |
| | 100 | | | | 96 | 177 | 22 |
| | 100 | | | | 97 | 177 | 22 |
| | 200 | | | | 87 | 115 | 55 |
| | 200 | | | | 87 | 116 | 52 |
| | 200 | | | | 87 | 116 | 52 |
| C | 25 | 91 | 103 | 21 | 93 | 188 | 20 |
| | 25 | 90 | 190 | 22 | 93 | 189 | 21 |
| | 25 | 90 | 192 | 23 | 93 | 186 | 20 |
| | 25 | 91 | 192 | 22 | 93 | 188 | 20 |
| | 25 | 90 | 191 | 22 | 93 | 188 | 20 |
| | 25 | 90 | 193 | 23 | 93 | 187 | 21 |
| | 100 | | | | 96 | 181 | 22 |
| | 100 | | | | 96 | 181 | 23 |
| | 100 | | | | 96 | 180 | 24 |
| | 200 | | | | 87 | 117 | [symbol] |
| | 200 | | | | 87 | 117 | 62 |
| | 200 | | | | 87 | 118 | 64 |

[symbol]

indicates data missing or illegible when filed

TABLE 18

| | | L direction | | | T direction | | |
|---|---|---|---|---|---|---|---|
| | Test | 0.2%-Proof | Tensile | | 0.2%-Proof | Tensile | |
| Specimen | temperature | stress | strength | Elongation | stress | strength | Elongation |
| symbol | [° C.] | [MPa] | [MPa] | [%] | [MPa] | [MPa] | [%] |
| D | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | | | | [symbol] | [symbol] | [symbol] |
| | [symbol] | | | | [symbol] | [symbol] | [symbol] |
| | [symbol] | | | | [symbol] | [symbol] | [symbol] |
| | [symbol] | | | | [symbol] | [symbol] | [symbol] |
| | [symbol] | | | | [symbol] | [symbol] | [symbol] |
| | [symbol] | | | | [symbol] | [symbol] | [symbol] |
| | [symbol] | | | | [symbol] | [symbol] | [symbol] |

[symbol]

indicates data missing or illegible when filed

TABLE 19

| | | L direction | | | T direction | | |
|---|---|---|---|---|---|---|---|
| | Test | 0.2%-Proof | Tensile | | 0.2%-Proof | Tensile | |
| Specimen | temperature | stress | strength | Elongation | stress | strength | Elongation |
| symbol | [° C.] | [MPa] | [MPa] | [%] | [MPa] | [MPa] | [%] |
| E | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | | | | [symbol] | [symbol] | [symbol] |
| | [symbol] | | | | [symbol] | [symbol] | [symbol] |
| | [symbol] | | | | [symbol] | [symbol] | [symbol] |
| | [symbol] | | | | [symbol] | [symbol] | [symbol] |
| | [symbol] | | | | [symbol] | [symbol] | [symbol] |
| | [symbol] | | | | [symbol] | [symbol] | [symbol] |

[symbol]

indicates data missing or illegible when filed

TABLE 20

| | | L direction | | | T direction | | |
|---|---|---|---|---|---|---|---|
| | Test | 0.2%-Proof | Tensile | | 0.2%-Proof | Tensile | |
| Specimen | temperature | stress | strength | Elongation | stress | strength | Elongation |
| symbol | [° C.] | [MPa] | [MPa] | [%] | [MPa] | [MPa] | [%] |
| [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | [symbol] | [symbol] | [symbol] | [symbol] | [symbol] | [symbol] |
| | [symbol] | | | | | [symbol] | [symbol] |
| | [symbol] | | | | | [symbol] | [symbol] |
| | [symbol] | | | | | [symbol] | [symbol] |
| | [symbol] | | | | | [symbol] | [symbol] |
| | [symbol] | | | | | [symbol] | [symbol] |
| | [symbol] | | | | | [symbol] | [symbol] |

[symbol]

indicates data missing or illegible when filed

“Conclusion”

Calculated on HZ-A3004-H112 was the change in the material property for expecting the designed storage term (60 years). Further, the specimen for the mechanical test simulating the material after the designed storage term was produced to perform the evaluation test for the material property. The results are shown below.

(1) The Larson-Miller parameter (LMP) was used to investigate the condition of the overaging heat treatment conservatively equivalent to the thermal history in the designed storage term. The heat treatment condition was determined as follows.

Heat treatment condition: O-material treatment (Annealed) overaging heat treatment (for example: 275° C.×1500 hours)

(2) With the simulation using Thermo-Calc and TC-Prisma, the addition amount of Mg into the specimen for the mechanical test was investigated. The addition amount of Mg into the specimen for the mechanical test was determined as follows.

Addition amount of Mg: 0.95 [mass %]

(3) The specimen for the mechanical test produced and heat-treated under the aforementioned conditions was used to perform the evaluation test for the material property, and the material strength corresponding to HZ-A3004-H112 after the designed storage term was obtained.

What is claimed is:

1. A method of estimating a solid solution amount of an additive element for estimating a change with time of the solid solution amount of the element added into an aluminum alloy, the method comprising the steps of:
identifying a precipitate of the aluminum alloy with an equilibrium diagram prepared based on a CALPHAD method; and
estimating the change with time of the solid solution amount of the additive element with a Langer-Schwartz theory and a numerical solution with a Kampmann-Wagner method based on the identified precipitate.

2. The method of estimating a solid solution amount of an additive element according to claim 1, the method comprising the steps of:
estimating a change with time of a solid solution amount of the element in each of the precipitate with the Langer-Schwartz theory and the numerical solution with the Kampmann-Wagner method based on the identified precipitate;
regulating an interface energy of each of the precipitate for an input to a simulation based on the Langer-Schwartz theory and the numerical solution with the Kampmann-Wagner method so that an estimation of a change in an electroconductivity based on the change with time of the solid solution amount of each element in each of the precipitate and in a base phase approaches a change in an electroconductivity in a heat treatment experiment; and
inputting the regulated interface energy to the simulation based on the Langer-Schwartz theory and the numerical solution with the Kampmann-Wagner method of estimating a change with time of a solid solution amount of Mg.

3. The method of estimating a solid solution amount of an additive element according to claim 1,
wherein the aluminum alloy is an aluminum alloy for a basket used for a metal cask, and
a term of estimating the change with time of the solid solution amount of the additive element is a designed storage term of the aluminum alloy for a basket used for the metal cask.

4. The method of estimating a solid solution amount of an additive element according to claim 2,
wherein the aluminum alloy is an aluminum alloy for a basket used for a metal cask, and
a term of estimating the change with time of the solid solution amount of the additive element is a designed storage term of the aluminum alloy for a basket used for the metal cask.

5. A method of producing a specimen simulating a change with time of a metallographic structure in a designed storage term of an aluminum alloy for a basket used for a metal cask, the method comprising steps of:
calculating a condition of an overaging heat treatment corresponding to a thermal history in the designed storage term of the aluminum alloy for a basket with a Larson-Miller equation using a constant obtained in a creep rupture test; and
performing the overaging heat treatment on an aluminum alloy to be a base material of the specimen based on the calculated condition of the overaging heat treatment.

6. A method of producing a specimen simulating a change with time of a metallographic structure in a designed storage term of an aluminum alloy for a basket used for a metal cask, the method comprising steps of:
estimating a solid solution amount of Mg in an end stage of the designed storage term of the aluminum alloy for a basket with the method of estimating a solid solution amount of an additive element according to claim 1;
estimating a solid solution amount of Mg in a stage corresponding the end stage of the designed storage term of the specimen with the method of estimating a solid solution amount of an additive element according to claim 1;
calculating a difference in a solid solution amount of Mg by subtracting the estimated solid solution amount of Mg in the aluminum alloy for a basket from the estimated solid solution amount of Mg in the specimen;
reducing an addition amount of Mg into an aluminum alloy to be a base material of the specimen by an amount of not less than the calculated difference in the solid solution amount of Mg;
calculating a condition of an overaging heat treatment corresponding to a thermal history in the designed storage term of the aluminum alloy for a basket with a Larson-Miller equation using a constant obtained in a creep rupture test; and
performing the overaging heat treatment on an aluminum alloy to be a base material of the specimen based on the calculated condition of the overaging heat treatment.

7. A method of producing a specimen simulating a change with time of a metallographic structure in a designed storage term of an aluminum alloy for a basket used for a metal cask, the method comprising steps of:
estimating a solid solution amount of Mg in an end stage of the designed storage term of the aluminum alloy for a basket with the method of estimating a solid solution amount of an additive element according to claim 2;
estimating a solid solution amount of Mg in a stage corresponding the end stage of the designed storage term of the specimen with the method of estimating a solid solution amount of an additive element according to claim 2;
calculating a difference in a solid solution amount of Mg by subtracting the estimated solid solution amount of Mg in the aluminum alloy for a basket from the estimated solid solution amount of Mg in the specimen;
reducing an addition amount of Mg into an aluminum alloy to be a base material of the specimen by an amount of not less than the calculated difference in the solid solution amount of Mg;
calculating a condition of an overaging heat treatment corresponding to a thermal history in the designed storage term of the aluminum alloy for a basket with a Larson-Miller equation using a constant obtained in a creep rupture test; and
performing the overaging heat treatment on an aluminum alloy to be a base material of the specimen based on the calculated condition of the overaging heat treatment.

8. A strength evaluation method of evaluating a change with time of a material strength of the aluminum alloy for a basket used for the metal cask based on the specimen produced with the method of producing a specimen according to claim 5.

9. A strength evaluation method of evaluating a change with time of a material strength of the aluminum alloy for a basket used for the metal cask based on the specimen produced with the method of producing a specimen according to claim 6.

10. A strength evaluation method of evaluating a change with time of a material strength of the aluminum alloy for a basket used for the metal cask based on the specimen produced with the method of producing a specimen according to claim 7.
